(19) United States
(12) Patent Application Publication
(10) Pub. No.: US 2024/0005209 A1
(43) Pub. Date: Jan. 4, 2024

(54) METHOD AND DEVICE FOR TRAINING A CLASSIFIER OR REGRESSOR FOR A ROBUST CLASSIFICATION AND REGRESSION OF TIME SERIES

(71) Applicant: Robert Bosch GmbH, Stuttgart (DE)

(72) Inventors: Frank Schmidt, Leonberg (DE); Joerg Schmitt, Ludwigsburg (DE); Julian Raible, Schömberg (DE); Marvin Frisch, Gaertringen (DE); Patrick Menold, Stuttgart (DE)

(21) Appl. No.: 18/248,432

(22) PCT Filed: Dec. 9, 2021
(86) PCT No.: PCT/EP2021/084990

§ 371 Date: Apr. 10, 2023

(30) Foreign Application Priority Data
Dec. 21, 2020 (DE) 20 2020 107 432.6
Feb. 9, 2021 (DE) 10 2021 201 179.9

(51) Int. Cl. G06N 20/00

(52) U.S. Cl. CPC G06N 20/00

(57) ABSTRACT

A computer-implemented method for training a machine learning system. The method includes: ascertaining a first training time series of input signals and a desired training output signal which corresponds to the first training time series, the desired training output signal characterizing a desired classification and/or a desired regression result of the first training time series; ascertaining a first adversarial example when is an overlap between the first training time series and an ascertained first adversarial perturbation, a first noise value of the first adversarial perturbation is not greater than a specifiable threshold, and the specifiable threshold is based on the ascertained noise values of the training time series; ascertaining a training output signal for the first adversarial example using the machine learning system; and adapting at least one parameter of the machine learning system according to a gradient of a loss value.

### FIELD

The present invention relates to a computer-implemented machine learning system, a training device for training the machine learning system, a computer program, and a machine-readable storage medium.

### BACKGROUND INFORMATION

Wong et al., “Neural Network Virtual Sensors for Fuel Injection Quantities with Provable Performance Specifications,” Jun. 30, 2020, available online https://arxiv.org/abs/2007.00147v1, describes a method for training a machine learning system by means of certifiable robustness training.

### SUMMARY

A technical system can be controlled depending on sensor measurements of its environment and/or sensor measurements of operating states of the technical system. In this respect, machine learning systems are typically used to process the sensor measurements. In general, such machine learning systems can be used as virtual sensors that may, for example, determine, on the basis of the sensor measurements, an operating state of the technical system that could otherwise not be ascertained by a sensor.

Sensors are generally subject to more or less strong noise and production tolerances that cause similar effects to noise from the perspective of the technical system. Even smaller noise components of a sensor measurement (due to sensor noise and/or production tolerances) can result in a false prediction of the machine learning system.

It is described in Wong et al. that a machine learning system can be trained such that it becomes more robust to noise.

However, the inventors have found that although the used attack models of the adversarial examples from conventional methods result in an increase in robustness to noise, the average predictive accuracy of a thus trained machine learning system is significantly reduced.

A significant advantage of a method according to the present invention is that a machine learning system configured to classify time series of sensor data or to perform a regression thereon can be trained such that it becomes more robust to noise and the average generalization capability is nevertheless not reduced. This advantageously increases the overall predictive accuracy of the machine learning system while the machine learning system also becomes robust to noise.

In a first aspect, the present invention relates to a computer-implemented method for training a machine learning system, wherein the machine learning system is configured to ascertain an output signal on the basis of a time series of input signals of a technical system, the output signal characterizing a classification and/or a regression result of at least one first operating state and/or at least one first operating variable of the technical system. According to an example embodiment of the present invention, the method comprises the following steps:
a. ascertaining a first training time series of input signals from a plurality of training time series and a desired training output signal which corresponds to the first training time series, the desired training output signal characterizing a desired classification and/or a desired regression result of the first training time series;
b. ascertaining a first adversarial example (x′ᵢ), wherein the first adversarial example is an overlap of the first training time series with an ascertained first adversarial perturbation, wherein a first noise value of the first adversarial perturbation is not greater than a specifiable threshold, wherein the specifiable threshold is based on the ascertained noise values of the training time series;
c. ascertaining a training output signal for the first adversarial example by means of the machine learning system; and
d. adapting at least one parameter of the machine learning system according to a gradient of a loss value, the loss value characterizing a deviation of the desired training output signal from the ascertained training output signal.

A time series can be understood as a plurality of input signals, the input signals respectively characterizing measurements of a sensor or operating states of the technical system. Time series can in particular be provided in the form of vectors, wherein the values of the vector can be understood as values of the different time points of the time series. Preferably, the values of the vector are sorted according to their measurement times, i.e., ascending dimensions of the vector indicate successive time points of the time series.

Alternatively, it is also possible for a time series to characterize a plurality of input signals at a respective time point. The time series can therefore be represented as a matrix in which, for example, a first dimension of the matrix characterizes time points, while a second dimension of the matrix characterizes the different input signals. For use in the suggested method for training, these time series can be used such that all rows or all columns of the matrix are concatenated in order to obtain a vector that can then be used in the method as a or as a training time series.

According to an example embodiment of the present invention, the training of the machine learning system can be understood as a supervised training. The first training time series used for the training may preferably comprise input signals that respectively characterize a second operating state and/or a second operating variable of the technical system or of a structurally identical technical system or of a structurally similar technical system or a simulation of the second operating state and/or of the second operating variable at a predefined time point. In other words, training time series of the plurality of training time series can be based on input signals of the technical system itself. Alternatively or additionally, it is possible that the training time series input signals are recorded by a similar technical system, wherein a similar technical system may, for example, be a prototype or an advance development of the technical system. It is also possible for the input signals of the training time series to be ascertained from another technical system, e.g., from another technical system of the same production line or production series. It is also possible that the input signals of the training time series are ascertained on the basis of a simulation of the technical system.

According to an example embodiment of the present invention, the input signals of the first training time series are similar to the input signals of the time series; in particular, the input signals of the training time series should characterize the same second operating variable as the input signals of the time series.

For training, the training time series can in particular be provided from a database, wherein the database comprises the plurality of training time series. For training, the steps a.-d. may preferably be performed iteratively. Preferably, a plurality of training time series may also be used in each iteration to ascertain the loss value, i.e., the training may also be carried out with a batch of training time series.

In one design of the method of the present invention, it is possible that for each training time series of a batch, it is determined in each case whether or not the training time series is to be overlapped with an adversarial perturbation. For this purpose, it is preferably determined randomly per training time series of the batch whether or not the training time series is to be overlapped with the adversarial perturbation. The advantage of this design form is that during training, the machine learning system does not only receive adversarial examples but also the training time series themselves. The inventors have found that this can further improve the predictive accuracy of the machine learning system.

The output signals may comprise a classification and/or a regression result. A result of regression is to be understood as a regression result. The machine learning system can therefore be considered as a classifier and/or regressor. The term “regressor” can be understood to mean a device that predicts at least one real value with respect to at least one real value.

The time series and the training time series are each preferably provided as a column vector, wherein one dimension of the vector respectively characterizes a measured value at a particular time point within the time series or the training time series.

According to an example embodiment of the present invention, for the method for training, the training time series and/or the desired training output signal can in particular be ascertained by means of sensor measurements of the technical system. Alternatively, it is also possible that the training time series and/or the desired training output signal be ascertained by means of a simulation of the technical system.

The machine learning system can be understood such that it is designed to receive a time series and to ascertain an output signal that characterizes a classification of the time series or ascertains at least one real value on the basis of the time series, i.e., performs a regression.

For this purpose, the machine learning system can in particular comprise a neural network that performs the classification or regression.

According to an example embodiment of the present invention, the machine learning method is trained by means of the method such that it becomes robust to noise in the time series passed to the machine learning system. For this purpose, particularly suitable adversarial examples for the machine learning system are ascertained and the machine learning system is subsequently trained to correctly classify the adversarial examples or to perform a correct regression.

An adversarial example can be understood as a first time series, which is ascertained on the basis of a second time series such that an incorrect classification is ascertained for the first time series or the machine learning system ascertains a regression result the distance of which from a desired regression result exceeds a tolerance threshold, wherein a prediction of the machine learning system with respect to the second time series is correct or the distance does not exceed the tolerance threshold.

The first time series, i.e., the adversarial example, can in particular be understood as an overlap of the second time series with an adversarial perturbation. The adversarial perturbation characterizes a change that can be made to the second time series in order to generate an adversarial example. Within the meaning of the present invention, adversarial examples and adversarial perturbation may preferably also be provided as vectors. An overlap of a training time series with an adversarial perturbation can therefore in particular be understood as a vector addition.

Within the meaning of the present invention, adversarial perturbations can also be understood as noise.

In order to generate adversarial examples, the possible adversarial perturbation are typically limited. A selected limitation induces a so-called attack model of the adversarial examples. Conventional attack models are the limitation of the adversarial perturbation to a sphere or a cube in the space of inputs of the machine learning system. However, the inventors have found that these conventional attack models result in ascertained adversarial perturbations also including perturbations that do not characterize realistic noise with respect to the time series. The inventors have furthermore found that limiting the attack model to realistic noise simplifies the training of the machine learning system significantly since the machine learning system does not have to be made robust to adversarial examples that do not represent realistic noise anyway and are therefore not expected. This increases the predictive accuracy of the machine learning system.

The method can therefore be understood such that it has the feature that only adversarial perturbations that characterize an expected noise are used for training. An expected noise can in particular be ascertained from the plurality of training input signals, i.e., as the average noise of the training input signals.

According to an example embodiment of the present invention, in the method, the first adversarial perturbation is limited such that a noise value of the first adversarial perturbation is not greater than the specifiable threshold.

In particular, the specifiable threshold may correspond to an average noise value of the training time series of the plurality of training time series. This advantageously further limits the adversarial perturbation such that it has a noise value that is less than or equal to an average noise value of the plurality of training time series.

According to an example embodiment of the present invention, the noise value can be understood as a value that characterizes the intensity of a noise. In this sense, a noise value can be ascertained for both an adversarial perturbation and an adversarial example or a time series.

Preferably, a noise value of a training time series or of an adversarial perturbation or of an adversarial example can be ascertained according to a Mahalanobis distance.

In particular, the Mahalanobis distance can characterize a distance of a training time series or of an adversarial perturbation or of an adversarial example from a statistical distribution of a noise of the training time series. It can thus be ascertained how much a noise present in a training time series or in an adversarial perturbation or in an adversarial example resembles an expected noise

According to an example embodiment of the present invention, preferably, the noise value can be ascertained according to the formula

r= [symbol] s,Cₖ⁺·s [symbol] ^{0.5},

wherein s is a training time series or an adversarial perturbation or an adversarial example, and Cₖ⁺ is a pseudo-inverse covariance matrix characterizing a specifiable number k of the greatest eigenvalues and corresponding eigenvectors of at least a subset of the plurality of training time series. Linear noise components in an input of the formula can in particular be ascertained by this preferred design of the method. The inventors have found that by determining in particular linear noise components, the ascertained adversarial perturbation can be limited even better to a noise expected for the time series. This advantageously further improves the predictive accuracy of the machine learning system.

If a noise value is to be ascertained for a time series, in particular a training time series, by means of the described formula, the expected value of the training time series (i.e., the midpoint of all training time series) can preferably be deducted from the time series. This in particular centers all training time series around the origin.

In particular, the matrix Cₖ⁺ can be ascertained on the basis of all training time series of the plurality of training time series.

Furthermore, it is possible that different matrices Cₖ⁺ are used for different training time series. For example, it is possible that the technical system is produced at different production sites, and the technical systems thus produced have different production tolerances. In this case, it is, for example, possible to ascertain the matrix Cₖ⁺ on the basis of training time series of technical systems of a respective product location.

Furthermore, according to an example embodiment of the present invention, it is possible that different matrices Cₖ⁺ are ascertained for different operating states of the technical system, and a matrix Cₖ⁺ is selected in the method according to an operating state characterized by the training time series. For example, the technical system may comprise a motor, and the operating state may characterize a rotation speed and/or an operating time and/or a temperature.

Furthermore, according to an example embodiment of the present invention, it is also possible to ascertain the matrix Cₖ⁺ depending on a training time series. For example, the training time series may be clustered by means of a clustering method, and a respective matrix Cₖ⁺ may be ascertained for each cluster on the basis of the training time series associated with the cluster. For training, a cluster closest to the training time series can first be ascertained in order to ascertain a noise value of a training time series, and the matrix Cₖ⁺ of the cluster can be used to determine the noise value of the training time series. For adversarial perturbations and adversarial examples, the matrix Cₖ⁺ of the cluster that is closest to the training time series for which the adversarial perturbation or the adversarial example is ascertained can be used in each case.

Specifically, according to an example embodiment of the present invention, the pseudo-inverse covariance matrix can be ascertained by the following steps:
e. ascertaining a covariance matrix of the at least subset of the plurality of training time series;
f. ascertaining at least one greatest eigenvalue, preferably a predefined plurality of greatest eigenvalues, of the covariance matrix as well as the eigenvectors correspond to the eigenvalue(s); and
g. ascertaining the pseudo-inverse covariance matrix according to the formula

$${C}_{k}^{+} = {\sum }_{i = 1}^{k} \frac{1}{{λ}_{i}} \cdot {v}_{i} {v}_{i}^{T} ,$$

wherein λᵢ is the i-th eigenvalue of the plurality of greatest eigenvalues, vᵢ is the eigenvector corresponding to the eigenvalue λᵢ, and k is the specifiable number of greatest eigenvalues.

If only one matrix Cₖ⁺ is to be ascertained for all training time series, all training time series can be used in step e.

The first noise signal can be ascertained on the basis of an optimization such that a distance of a second output signal from the desired output signal becomes as large as possible, wherein the second output signal is ascertained by the machine learning system on the basis of an overlap of the first training time series with the first noise signal. This approach can be understood as a form of training as can also be used for other types and/or attack models of adversarial examples. In particular, projected gradient descent (PGD) methods or methods of certifiable robustness training (provably robust defense or provable adversarial defense, see Wong et al.) may be used for this purpose.

In a preferred design of the method of the present invention, the first adversarial perturbation can be ascertained according to the following steps:
h. providing a second adversarial perturbation;
i. ascertaining a third adversarial perturbation, wherein with respect to the first training time series (x′ᵢ), the third adversarial perturbation is stronger than the second adversarial perturbation;
j. providing the third adversarial perturbation as the first adversarial perturbation if a distance of the third adversarial perturbation from the second adversarial perturbation is less than or equal to a predefined threshold;
k. otherwise, if a noise value of the third adversarial perturbation is less than or equal to an expected noise value, performing step i., wherein, in the performance of step i., the third adversarial perturbation is used as the second adversarial perturbation;
l. otherwise, ascertaining a projected perturbation and performing step j., wherein, in the performance of step j., the projected perturbation is used as the third adversarial perturbation, and wherein the projected perturbation is ascertained by an optimization such that a distance of the projected perturbation from the second adversarial perturbation is as small as possible and the noise value of the projected perturbation is equal to the expected noise value.

This design of the method can be understood as a form of PGD, wherein the attack model is, however, limited to the expected noise of the plurality of the training time series. In particular, in step h., the first adversarial perturbation can be ascertained randomly. Alternatively, in step h., the first adversarial perturbation can contain at least one predefined value.

An advantage of this design of the method of the present invention is that the machine learning system can be trained using PGD, wherein the attack model is limited to an expected noise of the plurality of training time series. As a result, the machine learning system advantageously becomes more robust to noise, wherein the predictive accuracy of the machine learning system is advantageously not degraded in comparison to other attack models.

According to an example embodiment of the present invention, the first training time series can be overlapped with the second adversarial perturbation in order to obtain a second adversarial example, and the first training time series can be overlapped with the third adversarial perturbation in order to obtain a third adversarial example. For the second adversarial example, a second output signal can then be ascertained, and a third output signal can be ascertained for the third adversarial output signal. The third adversarial perturbation can then be understood to be stronger than the second adversarial perturbation if the third output signal is further away from the desired training output signal than the second output signal is. Conversely, it is possible to ascertain the third adversarial perturbation using gradient ascent and on the basis of the second adversarial perturbation.

Preferably, for this purpose, in step i., the third adversarial perturbation can be ascertained by means of a gradient ascent on the basis of an output of the machine learning system (60) with respect to the first training time series overlapped with the second adversarial perturbation and with respect to the desired training output, wherein the gradient for the gradient ascent is adapted according to the eigenvalues and eigenvectors.

Preferably, for this purpose, in step i., the third adversarial perturbation can be ascertained by means of a gradient ascent on the basis of an output of the machine learning system (60) with respect to the first training time series (xᵢ) overlapped with the second adversarial perturbation and with respect to the desired training output (tᵢ), wherein the gradient for the gradient ascent is adapted according to the eigenvalues and eigenvectors.

This preferred design of the method of the present invention can be understood such that in step i., the third adversarial perturbation is ascertained according to the formula

δ₃=δ₂+a·Cₖ·g,

wherein δ₂ is the second adversarial perturbation, δ₃ is the third adversarial perturbation, a is a specifiable step-width value, Cₖ is a first matrix, and g is a gradient, wherein the gradient g is ascertained according to the formula

g=∇ₓ_{ᵢ}[L(m(xᵢ+δ₂),tᵢ)],

wherein L is a loss function, tᵢ is the desired training output signal with respect to the first training time series, and m(xᵢ+δ₂) is the result of the machine learning system if the first training time series overlapped with the second adversarial perturbation δ₂ is passed to the machine learning system.

The projected adversarial perturbation can be ascertained according to the formula

$${δ}_{p} = {argmin}_{d , r ( d , {C}_{k}^{+} ) = Δ} {‖ d - {δ}_{3} ‖}_{2} .$$

The matrix Cₖ can in this case be ascertained according to the greatest eigenvalues and the corresponding eigenvectors of the covariance matrix of the plurality of training time series, i.e., according to the formula

$${C}_{k} = {\sum }_{i = 1}^{k} {λ}_{i} \cdot {v}_{i} {v}_{i}^{T} .$$

An advantage of ascertaining the gradient on the basis of the greatest eigenvalues and eigenvectors is that the number of steps of the PGD method for ascertaining the first adversarial perturbation can be reduced since from the perspective of the gradient ascent, the matrix Cₖ directs the gradient in a better direction, which in fewer steps results in an adversarial perturbation that is strong and whose noise value is less than the average noise value of the plurality of training time series. This procedure can be understood to be similar to a gradient ascent by means of a natural gradient. Reducing the number of steps results in a shorter training time. With the same training time, the machine learning system can therefore be trained on more training time series, resulting in an increase in the predictive accuracy of the machine learning system.

In a further design of the method of the present invention, it is possible that the first adversarial example is ascertained by means of certifiable robustness training.

In particular, the method described in Wong et al., “Scaling provable adversarial defenses,” Nov. 21, 2018, available online https://arxiv.org/abs/1805.12514v2, can be modified such that it uses the attack model proposed according to the present invention. This can be achieved such that equation 7 is modified such that instead of ε∥v₁∥_{*}, the term Δ·r(v₁) is used, wherein Δ is the average noise value of the plurality of training time series and is ascertained according to the formula

$$Δ = \frac{1}{n} {\sum }_{i = 1}^{n} {‖ {x}_{i} - f ( {x}_{i} ) ‖}_{2 ,}$$

wherein n the number of training time series of the plurality of training time series.

An advantage of this design of the method is that the machine learning system can provably be reliably trained against noise. The predictive accuracy of the machine learning system under noise can thereby be demonstrably ascertained. In addition, the predictive accuracy of the machine learning system is increased in comparison to a training by means of normal certifiable robustness training.

In particular, according to an example embodiment of the present invention, the technical system can dispense a liquid via a valve, wherein the time series and the training time series each characterize a sequence of pressure values of the technical system, and the output signal and the desired training output signal each characterize an amount of liquid dispensed by the valve.

In one design of the method of the present invention, the technical system may, for example, be the fuel injection of a combustion engine. The valves may be injectors of the combustion engine, e.g., diesel injectors or gasoline fuel injector. Typically, the amount of fuel dispensed in an injection operation can be ascertained only with difficulty. The advantage of the method is that the machine learning system acts as a virtual sensor by means of which an injected amount of fuel can be ascertained very accurately. By using the method, the machine learning system also becomes robust to noise from the sensors determining the pressure in a fuel line, the fuel line guiding the fuel to the valve. The machine learning system also becomes more robust to noise from the sensors, which is caused by production-related differences in the sensors.

In a further design according to the present invention, the technical system may, for example, be a spray system used in agriculture to spray fields, for example a fertilizer system. In such systems, it is also necessary to precisely determine the amount of fertilizer dispensed via the valve, in order to avoid over-fertilizing but also under-fertilizing of the field. Advantageously, the machine learning system is capable of very accurately ascertaining the amount of fertilizer dispensed by the valve.

Furthermore, according to an example embodiment of the present invention, it is possible for the method to be used for controlling a robot. In this case, the technical system is c, and the time series and the training time series can each characterize accelerations or position data of the robot ascertained by means of a corresponding sensor, wherein the output signal or the desired training output signal characterizes a position and/or an acceleration and/or a center of gravity and/or a zero moment point of the robot. The advantage of this approach is that the operating state of the robot to be ascertained can also be ascertained very accurately under noise, which advantageously results in improved control of the robot.

Furthermore, according to an example embodiment of the present invention, it is possible for the technical system to be a production machine that produces at least one part, wherein the input signals of the time series (x) each characterize a force and/or a torque of the production machine, and the output signal (y) characterizes a classification as to whether or not the part was produced correctly. In this design of the method, the advantage is that the part can be produced by the production machine with higher precision since a corresponding operating state of the machine can be predicted more accurately by the machine learning system, even under noise from the sensors.

Embodiments of the present invention are explained in greater detail below with reference to the figures.

### BRIEF DESCRIPTION OF THE DRAWINGS

FIG. 1 schematically illustrates a training system for training a machine learning system, according to an example embodiment of the present invention.

FIG. 2 schematically illustrates a structure of a control system for controlling an actuator by means of the machine learning system, according to an example embodiment of the present invention.

FIG. 3 schematically illustrates an exemplary embodiment for controlling a production system, according to the present invention.

FIG. 4 schematically illustrates an exemplary embodiment for controlling a system for spraying a liquid by means of a valve, according to the present invention.

FIG. 5 schematically illustrates an exemplary embodiment for controlling a robot, according to the present invention.

### DETAILED DESCRIPTION OF EXAMPLE EMBODIMENTS

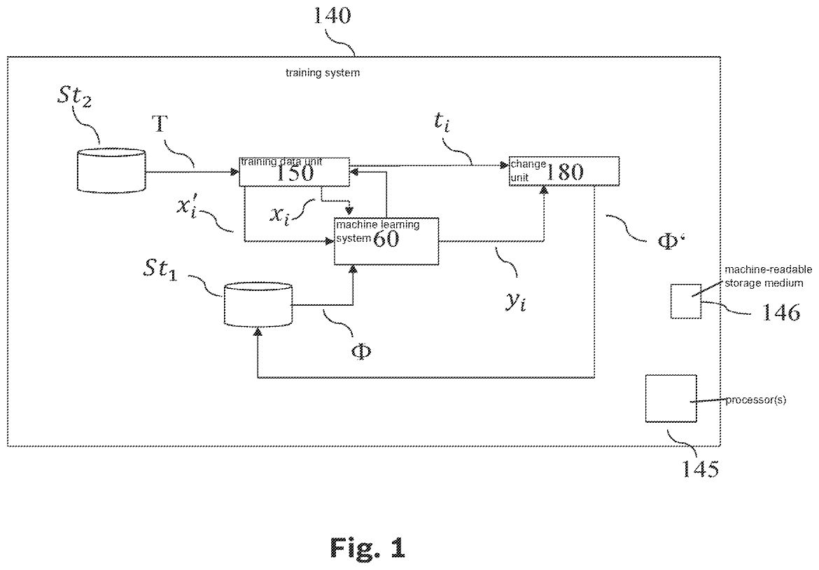

FIG. 1 shows an exemplary embodiment of a training system (140) for training a machine learning system (60) by means of a training data set (T). Preferably, the machine learning system (60) comprises a neural network. The training data set (T) comprises a plurality of training time series (xᵢ) of input signals of a sensor of a technical system, wherein the training time series (xᵢ) that are used to train the machine learning system (60), wherein the training data set (T) further comprises, for each training time series (xᵢ), a respective desired training output signal (tᵢ) which corresponds to the training time series (xᵢ) and characterizes a classification and/or a regression result with regard to the training time series (xᵢ). The training time series (xᵢ) are preferably provided in the form of a vector, wherein the dimensions respectively characterize time points of the training time series (xᵢ). Preferably, the training time series (xᵢ) are pre-processed such that a midpoint of the training time series (xᵢ) is a zero vector.

For the training, a training data unit (150) accesses a computer-implemented database (St₂), wherein the database (St₂) provides the training data set (T). The training data unit (150) first ascertains a first matrix from the plurality of training time series (xᵢ). For this purpose, the training data unit (150) first ascertains the empirical covariance matrix of the training time series (xᵢ). Subsequently, the k greatest eigenvalues as well as the associated eigenvectors can be ascertained and the first matrix Cₖ can be ascertained according to the formula

Cₖ=Σᵢ₌₁^{k}λᵢ·vᵢvᵢ^{T},

wherein λᵢ is one of the k greatest eigenvalues, vᵢ is the eigenvector associated with λᵢ in column form, and k is a predefined value. In further exemplary embodiments, it is also possible that only the greatest eigenvalue as well as the associated eigenvector are ascertained and the matrix Cₖ is ascertained on the basis of only this one eigenvalue.

In addition, a pseudo-inverse covariance matrix Cₖ⁺ is ascertained according to the formula

$${C}_{k}^{+} = {\sum }_{i = 1}^{k} \frac{1}{{λ}_{i}} \cdot {v}_{i} {v}_{i}^{T} .$$

In addition, an expected noise value Δ of the plurality of training time series (xᵢ) is ascertained according to the formula

$$Δ = \frac{1}{n} {\sum }_{i = 1}^{n} {〈 {x}_{i} , {C}_{k}^{+} \cdot {x}_{i} 〉}^{0.5} ,$$

wherein n is the number of training time series (xᵢ) in the training data set (T).

From the training data set (T), the training data unit (150) subsequently ascertains, preferably randomly, at least one first training time series (xᵢ) and the desired training output signal (tᵢ) corresponding to the training time series (xᵢ). On the basis of the machine learning system (60), the training data unit (150) then ascertains a first adversarial perturbation according to the following step:
h. providing a second adversarial perturbation δ₂, wherein a null vector that has the same dimensionality as the first training time series (xᵢ) is selected as the second adversarial perturbation;
i. ascertaining a third adversarial perturbation according to the formula

δ₃=δ₂+a·Cₖ·g,

wherein a is a specifiable step width and g is a gradient that is ascertained according to the formula

g=∇ₓ_{ᵢ}[L(m(xᵢ+δ₂),tᵢ)],

wherein m(xᵢ+δ₂) is the output of the machine learning system (60) with respect to an overlap of the first training time series (xᵢ) with the second adversarial perturbation;
j. providing the third adversarial perturbation as the first adversarial perturbation if a Euclidean distance of the third adversarial perturbation from the second adversarial perturbation is less than or equal to a specifiable threshold;
k. otherwise, if the noise value

r(δ₃,Cₖ⁺)= [symbol] δ₃,Cₖ⁺·δ₃ [symbol] ^{0.5}

of the third adversarial perturbation is less than or equal to an expected noise value Δ, performing step i., wherein, in the performance of step i., the third adversarial perturbation is used as the second adversarial perturbation;
l. otherwise, ascertaining a projected perturbation according to the formula

$${δ}_{p} = {argmin}_{d , r ( d , {C}_{k}^{+} ) = Δ} {‖ d - {δ}_{3} ‖}_{2}$$

and performing step p., wherein, in the performance of step p., the projected perturbation is used as the second adversarial perturbation.

Steps h. to l. can be understood such that an adversarial perturbation that becomes increasingly stronger with each iteration is ascertained iteratively, wherein the adversarial perturbation is in each case limited to the expected noise of the training time series (x′ᵢ). This approach can be understood as a modified form of PGD.

On the basis of the first adversarial perturbation provided, a first adversarial example (x′ᵢ) according to the formula

x′ᵢ=xᵢ+δ₁

is then ascertained.

In alternative exemplary embodiments, instead of ascertaining the first adversarial example by means of PGD, the first adversarial example can also be ascertained by means of certifiable robustness training.

The first adversarial example (x′ᵢ) is then transmitted to the machine learning system (60) and a training output signal (y) for the first adversarial example (x′ᵢ) is ascertained by the machine learning system (60).

The desired training output signal (tᵢ) and the ascertained training output signal (yᵢ) are transmitted to a change unit (180).

On the basis of the desired training output signal (tᵢ) and the ascertained output signal (yᵢ), new parameters (Φ′) for the machine learning system (60) are then determined by the change unit (180). For this purpose, the change unit (180) compares the desired training output signal (tᵢ) and the ascertained training output signal (yᵢ) by means of a loss function. The loss function ascertains a first loss value that characterizes how far the ascertained training output signal (yᵢ) deviates from the desired training output signal (tᵢᵢ). In the exemplary embodiment, a negative log-likehood function is selected as the loss function. In alternative exemplary embodiments, other loss functions are also possible.

The change unit (180) ascertains the new parameters (Φ′) on the basis of the first loss value. In the exemplary embodiment, this is done by means of a gradient descent method, preferably stochastic gradient descent, Adam, or AdamW.

The ascertained new parameters (Φ′) are stored in a model parameter memory (St₁). The ascertained new parameters (Φ′) are preferably provided as parameters (Φ) to the classifier (60).

In further preferred exemplary embodiments, the described training is iteratively repeated for a predefined number of iteration steps or is iteratively repeated until the first loss value falls below a predefined threshold. Alternatively, or additionally, it is also possible that the training is terminated if an average first loss value with respect to a test or validation data set falls below a predefined threshold. In at least one of the iterations, the new parameters (Φ′) determined in a previous iteration are used as parameters (Φ) of the classifier (60). Alternatively or additionally, it is also possible that in each iteration, it is determined randomly whether the output signal (yᵢ) is ascertained for the first adversarial example (x′ᵢ) or for the training time series (xᵢ). In other words, in each iteration, it is randomly determined whether the machine learning system (60) of the respective iteration is to be trained on an intentionally noisy datum or on an input datum as recorded by a sensor.

Furthermore, the training system (140) may comprise at least one processor (145) and at least one machine-readable storage medium (146) containing instructions that, when executed by the processor (145), cause the training system (140) to carry out a training method according to one of the aspects of the present invention.

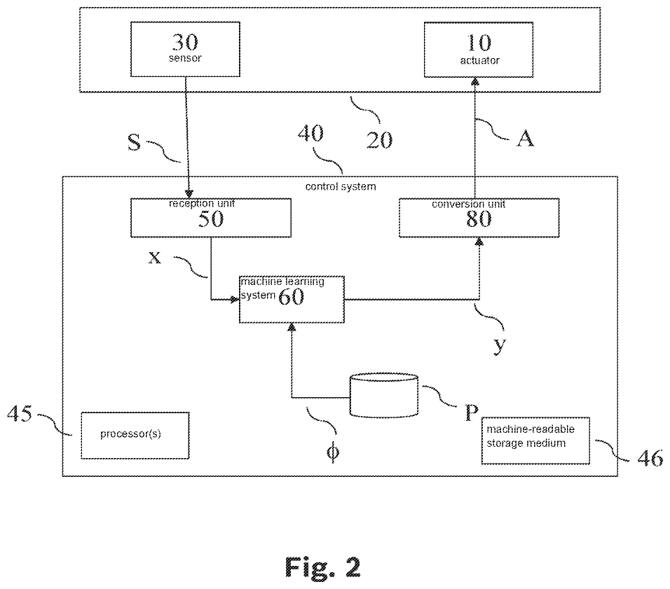

FIG. 2 shows a control system (40) controlling an actuator (10) of a technical system by means of a machine learning system (60), wherein the machine learning system (60) has been trained by means of the training device (140). At preferably regular intervals, a second operating variable or a second operating state is sensed using a sensor (30). The sensed input signal (S) of the sensor (30) is transmitted to the control system (40). The control system (40) thus receives a sequence of input signals (S). Therefrom, the control system (40) ascertains control signals (A), which are transmitted to the actuator (10).

The control system (40) receives the sequence of input signals (S) of the sensor (30) in a reception unit (50) that converts the sequence of input signals (S) into a time series (x). This may take place, for example, via a series of a predefined number of recently received input signals (S). In other words, the time series (x) is ascertained depending on the input signals (S). The time series (x) is supplied to the machine learning system (60). Preferably, prior to supplying the time series (x), the midpoint of the training time series (xᵢ) is deducted from the time series (x).

The machine learning system (60) ascertains an output signal (y) from the time series (x). The output signal (y) is supplied to an optional conversion unit (80), which therefrom ascertains control signals (A), which are supplied to the actuator (10) in order to control the actuator (10) accordingly.

The actuator (10) receives the control signals (A), is controlled accordingly, and carries out a corresponding action. The actuator (10) can comprise a (not necessarily structurally integrated) control logic which, from the control signal (A), ascertains a second control signal which is then used to control the actuator (10).

In further embodiments, the control system (40) comprises the sensor (30). In still further embodiments, the control system (40) alternatively or additionally also comprises the actuator (10).

In further preferred embodiments, the control system (40) comprises at least one processor (45) and at least one machine-readable storage medium (46) in which instructions are stored that, when executed on the at least one processor (45), cause the control system (40) to carry out the method according to the present invention.

In alternative embodiments, as an alternative or in addition to the actuator (10), a display unit (10a) is provided.

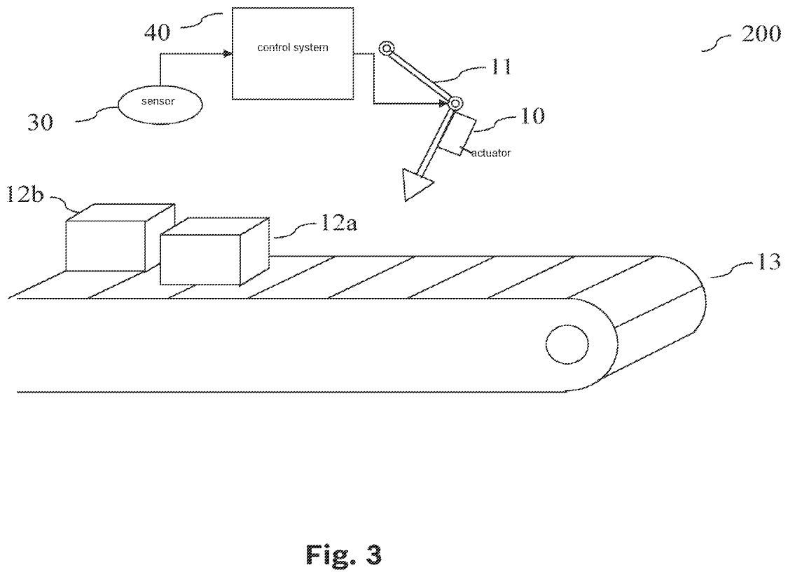

FIG. 3 shows an exemplary embodiment in which the control system (40) is used to control a production machine (11) of a production system (200) by controlling an actuator (10) controlling the production machine (11). For example, the production machine (11) may be a machine for welding.

The sensor (30) may preferably be a sensor (30) that ascertains a voltage of the welding device of the production machine (11). The machine learning system (60) can in particular be trained to classify, on the basis of a time series (x) of voltages, whether or not the welding operation was successful. The actuator (10) can automatically reject a corresponding part if the welding operation is unsuccessful.

In an alternative exemplary embodiment, it is also possible for the production machine (11) to join two parts by means of a pressure. In this case, the sensor (30) can be a pressure sensor and the machine learning system (60) can ascertain whether or not the joint was correct.

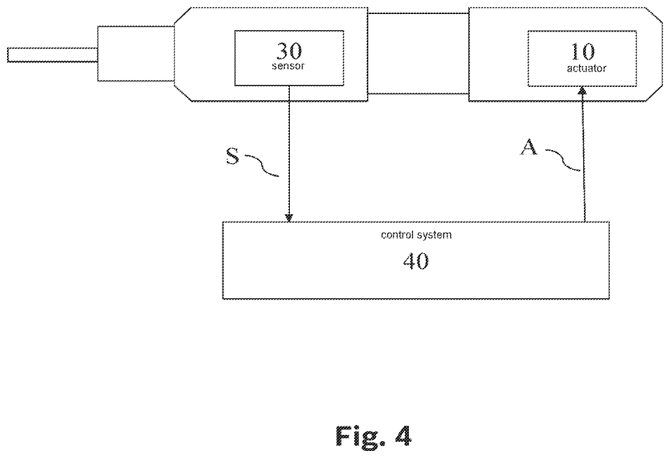

FIG. 4 shows an exemplary embodiment for controlling a valve (10). In the exemplary embodiment, the sensor (30) is a pressure sensor that determines a pressure of a liquid that can be dispensed by the valve (10). In particular, the machine learning system (60) can be designed to accurately ascertain, on the basis of the time series (x) of pressure values, an injection amount of liquid dispensed through the valve (10).

In particular, the valve (10) can be part of a fuel injector of a combustion engine, wherein the valve (10) is configured to inject fuel into the combustion engine. On the basis of the ascertained injection amount, the valve (10) can then be controlled in future injection operations such that too large an amount of injected fuel or too little an amount of injected fuel is compensated appropriately.

Alternatively, it is also possible for the valve (10) to be part of an agricultural fertilizer system, wherein the valve (10) is designed to spray fertilizer. On the basis of the ascertained sprayed amount of fertilizer, the valve (10) can then be controlled in future spraying operations such that too large an amount of sprayed fertilizer or too little an amount of sprayed fertilizer is compensated appropriately.

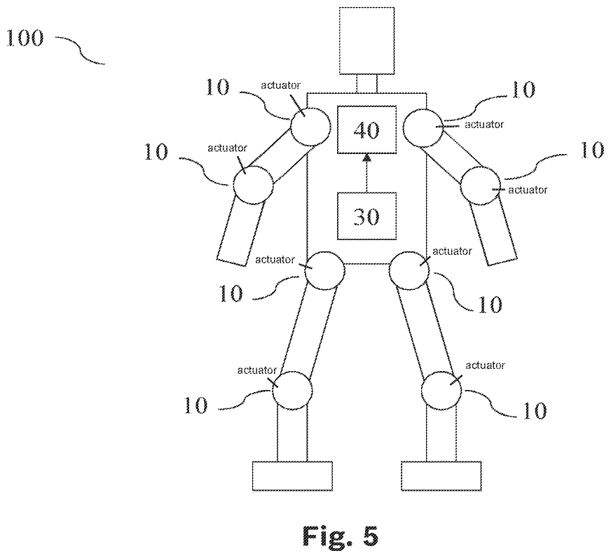

FIG. 5 shows how the control system (40) can be used to control a robot (100). In the exemplary embodiment, the robot (100) is a humanoid robot. The robot has at least one accelerometer (30) by means of which an acceleration of a center of gravity of the robot can be measured. The time series (x) in this application example is therefore a time series (x) of acceleration values. In particular, the machine learning system (60) can be designed to ascertain an actual acceleration of the robot (100) on the basis of the acceleration values. Alternatively, it is also possible for the machine learning system (60) to ascertain a zero moment point of the robot (100). On the basis of the ascertained output of the machine learning system (60), at least one actuator (10) of the robot can then be controlled, wherein the actuator (10) can move elements of the robot (100).

Alternatively, it is also possible that the at least one sensor (30) is a position sensor, for example a GPS sensor. In this case, the robot can ascertain a precise position of the robot (100) on the basis of the time series (x). Alternatively, it is also possible for a speed of the robot (100) to be ascertained on the basis of the time series (x).

In further exemplary embodiments (not shown), the robot (100) can also be a robot that moves by rolling, e.g., an at least partially automated vehicle. In this case, the time series (x) may, for example, characterize measurement data of a brake of the robot (100), wherein the machine learning system (60) is designed to determine whether or not the brake is defective. In the event that the brake has been classified as defective by the machine learning system (60), the control system (40) can select the control signal (A) such that a range of functions of the robot (100) is limited. For example, it is possible that in this case, a maximum possible speed of the robot (100) is limited. Alternatively or additionally, it is possible that the actuator (10) controls a display device on which is output that the brake has been classified as defective. Temperatures of the brake and/or sound volumes during braking operations can in particular be ascertained by the sensor (30) as measurement data of the brake.

The term “computer” includes any device for processing specifiable calculation rules. These calculation rules can be provided in the form of software or in the form of hardware or else in a mixed form of software and hardware.

A plurality can be generally be understood as being indexed, i.e., each element of the plurality is assigned a unique index, preferably by assigning consecutive integers to the elements contained in the plurality. If a plurality comprises N elements, wherein N is the number of elements in the plurality, the elements are preferably assigned whole numbers from 1 to N.

1-15. (canceled)

16. A computer-implemented method for training a machine learning system, the machine learning system being configured to ascertain an output signal based on a time series of input signals of a technical system, the output signal characterizing a classification and/or a regression result of at least one first operating state and/or at least one first operating variable of the technical system, the method comprising the following steps:
a. ascertaining a first training time series of input signals from a plurality of training time series and a desired training output signal which corresponds to the first training time series, the desired training output signal characterizing a desired classification and/or a desired regression result of the first training time series;
b. ascertaining a first adversarial example, wherein the first adversarial example is an overlap of the first training time series with an ascertained first adversarial perturbation, wherein a first noise value of the first adversarial perturbation is not greater than a specifiable threshold, wherein the specifiable threshold is based on ascertained noise values of the training time series;
c. ascertaining a training output signal for the first adversarial example using the machine learning system; and
d. adapting at least one parameter of the machine learning system according to a gradient of a loss value, the loss value characterizing a deviation of the desired training output signal from the ascertained training output signal.

17. The method according to claim 16, wherein the specifiable threshold corresponds to an average noise value of the first training time series of the plurality of training time series.

18. The method according to claim 16, wherein a noise value of each training time series or adversarial perturbation or adversarial example is ascertained according to a Mahalanobis distance.

19. The method according to claim 18, wherein the noise value is ascertained according to the formula
r= [symbol] s,Cₖ⁺·s [symbol] ^{0.5},
wherein s is the training time series or adversarial perturbation or adversarial example, and Cₖ⁺ is a pseudo-inverse covariance matrix characterizing a specifiable number k of greatest eigenvalues and corresponding eigenvectors of at least a subset of the plurality of training time series.

20. The method according to claim 19, wherein the pseudo-inverse covariance matrix is ascertained by the following steps:
e. ascertaining a covariance matrix of the at least subset of the plurality of training time series;
f. ascertaining a predefined plurality of greatest eigenvalue of the covariance matrix and eigenvectors corresponding to the eigenvalue;
g. ascertaining the pseudo-inverse covariance matrix according to the formula
$${C}_{k}^{+} = {\sum }_{i = 1}^{k} \frac{1}{{λ}_{i}} \cdot {v}_{i} {v}_{i}^{T} ,$$
wherein λᵢ is the i-th eigenvalue of the plurality of greatest eigenvalues, vᵢ is the eigenvector corresponding to the eigenvalue λᵢ, and k is the specifiable number of greatest eigenvalues.

21. The method according to claim 16, wherein the first adversarial perturbation is ascertained according to the following steps:
h. providing a second adversarial perturbation;
i. ascertaining a third adversarial perturbation, wherein with respect to the first training time series, the third adversarial perturbation is stronger than the second adversarial perturbation;
j. providing the third adversarial perturbation as the first adversarial perturbation when a distance of the third adversarial perturbation from the second adversarial perturbation is less than or equal to a specifiable threshold;
k. otherwise, when a noise value of the third adversarial perturbation is less than or equal to an expected noise value, performing step i., wherein, in the performance of step i., the third adversarial perturbation is used as the second adversarial perturbation;
l. otherwise, ascertaining a projected perturbation and performing step j., wherein, in the performance of step j., the projected perturbation is used as the third adversarial perturbation, and wherein the projected perturbation is ascertained by an optimization such that a distance of the projected perturbation from the second adversarial perturbation is as small as possible and the noise value of the projected perturbation is equal to the expected noise value.

22. The method according to claim 21, wherein, in step i., the third adversarial perturbation is ascertained using a gradient ascent based on an output of the machine learning system with respect to the first training time series overlapped with the second adversarial perturbation and with respect to the desired training output signal, wherein the gradient for the gradient ascent is adapted according to the eigenvalues and eigenvectors.

23. The method according to claim 16, wherein the first adversarial example is ascertained using certifiable robustness training.

24. The method according to claim 16, wherein the technical system dispenses a liquid via a valve, wherein each time series and each training time series characterizes a sequence of pressure values of the technical system, and the output signal and the desired training output signal each characterize an amount of liquid dispensed by the valve.

25. The method according to claim 16, wherein the technical system is a robot and each time series and each training time series characterizes accelerations or position data of the robot ascertained using a corresponding sensor, and the output signal or the desired training output signal characterizes a position and/or an acceleration and/or a center of gravity and/or a zero moment point of the robot.

26. The method according to claim 16, wherein the technical system is a production machine that produces at least one part, wherein the input signals of each the time series each characterize a force and/or a torque of the production machine, and the output signal characterizes a classification as to whether or not the part was produced correctly.

27. A machine learning system configured to ascertain an output signal based on a time series of input signals of a technical system, the output signal characterizing a classification and/or a regression result of at least one first operating state and/or at least one first operating variable of the technical system, the machine learning system trained by:
a. ascertaining a first training time series of input signals from a plurality of training time series and a desired training output signal which corresponds to the first training time series, the desired training output signal characterizing a desired classification and/or a desired regression result of the first training time series;
b. ascertaining a first adversarial example, wherein the first adversarial example is an overlap of the first training time series with an ascertained first adversarial perturbation, wherein a first noise value of the first adversarial perturbation is not greater than a specifiable threshold, wherein the specifiable threshold is based on ascertained noise values of the training time series;
c. ascertaining a training output signal for the first adversarial example using the machine learning system; and
d. adapting at least one parameter of the machine learning system according to a gradient of a loss value, the loss value characterizing a deviation of the desired training output signal from the ascertained training output signal.

28. A training device configured to train a machine learning system, the machine learning system being configured to ascertain an output signal based on a time series of input signals of a technical system, the output signal characterizing a classification and/or a regression result of at least one first operating state and/or at least one first operating variable of the technical system, the training device configured to:
a. ascertain a first training time series of input signals from a plurality of training time series and a desired training output signal which corresponds to the first training time series, the desired training output signal characterizing a desired classification and/or a desired regression result of the first training time series;
b. ascertain a first adversarial example, wherein the first adversarial example is an overlap of the first training time series with an ascertained first adversarial perturbation, wherein a first noise value of the first adversarial perturbation is not greater than a specifiable threshold, wherein the specifiable threshold is based on ascertained noise values of the training time series;
c. ascertain a training output signal for the first adversarial example using the machine learning system; and
d. adapt at least one parameter of the machine learning system according to a gradient of a loss value, the loss value characterizing a deviation of the desired training output signal from the ascertained training output signal.

29. A non-transitory machine-readable storage medium on which is stored a computer program for training a machine learning system, the machine learning system being configured to ascertain an output signal based on a time series of input signals of a technical system, the output signal characterizing a classification and/or a regression result of at least one first operating state and/or at least one first operating variable of the technical system, the computer program, when executed by a processor, causing the processor to perform the following steps:
a. ascertaining a first training time series of input signals from a plurality of training time series and a desired training output signal which corresponds to the first training time series, the desired training output signal characterizing a desired classification and/or a desired regression result of the first training time series;
b. ascertaining a first adversarial example, wherein the first adversarial example is an overlap of the first training time series with an ascertained first adversarial perturbation, wherein a first noise value of the first adversarial perturbation is not greater than a specifiable threshold, wherein the specifiable threshold is based on ascertained noise values of the training time series;
c. ascertaining a training output signal for the first adversarial example using the machine learning system; and
d. adapting at least one parameter of the machine learning system according to a gradient of a loss value, the loss value characterizing a deviation of the desired training output signal from the ascertained training output signal.
